(19) United States
(12) Patent Application Publication
(10) Pub. No.: US 2014/0176859 A1
(43) Pub. Date: Jun. 26, 2014

(54) WIDE-COLOR GAMUT FILM, DISPLAY APPARATUS WITH THE WIDE-COLOR GAMUT FILM, AND METHOD FOR MANUFACTURING THE FILM

(71) Applicant: EXTEND OPTRONICS CORP., Taoyuan County (TW)

(72) Inventors: Chao-Ying LIN, New Taipei City (TW); Jen-Huai CHANG, Taoyuan County (TW)

(73) Assignee: EXTEND OPTRONICS CORP., Taoyuan County (TW)

(21) Appl. No.: 13/721,909

(22) Filed: Dec. 20, 2012

(51) Int. Cl. G02F 1/1335

(52) U.S. Cl. CPC G02F 1/133514; G02F 1/133528; G02F 1/133516
USPC 349/62; 349/106; 349/96; 29/428

(57) ABSTRACT

Disclosed are a wide-color gamut film and its applications. While the wide-color gamut film is manufactured, the method firstly confirms the type of the backlight. The film is designed to filter some specified frequency bands, especially the bands adjacent to the frequencies of red, green and blue lights. The parameters are referred to decide an overall thickness and an overall refractive index, and prepare a plurality of high-polymeric thin films. A wide-color gamut film is formed by assembling the thin films according to the configuration. The invention also relates to a display using the wide-color gamut film. The film is disposed between a panel module and a backlight module of the display. The film serves to reduce or filter out the light transmittance within the determined bands. The wide-color gamut film is provided for improving the crosstalk phenomenon among the frequency bands of the backlight.

### BACKGROUND OF THE INVENTION

1. Field of the Invention

The present disclosure is related to a wide-color gamut film a display apparatus having the film, and a method for manufacturing the wide-color gamut film, in particular, the multiple films having an overall specific thickness and refractive index allow the wide-color gamut film to filter out the light with a specific waveband.

2. Description of Related Art

One of the functions of a display is to reproduce colors. The related technology incorporates a computer to processing an image for reproducing its colors. However, a performance of color gamut of display is directed to whether or not the colors may be completely reproduced. In color reproduction, the color gamut indicates a colors subset. The color subset, in general, accurately represents the colors in a given circumstance. For example, the color gamut indicates a color space or range of color of an output device such as a display.

Main structure of a common liquid crystal display (LCD) is composed of a backlight module and a liquid crystal panel. The backlight module provides a back light since the liquid panel is not able to illuminate. The performance of color gamut is one of the most important factors to define a display. Some other factors relating the performance of the display are such as resolution, response time, contrast and brightness. Further, the performance of color gamut to the display depends on the spectrum properties of the backlight module and the filters on the liquid crystal panel.

The types of the backlight module for a common LCD are a direct-type backlight and an edge-type backlight. The direct-type backlight module is exemplarily illustrated as in U.S. Pat. No. 7,481,563 or U.S. Pat. No. 7,425,729. In the direct-type backlight module, the light issued from a light source uniformly enters the LCD panel through some optical elements such as diffuser or diffusing film. U.S. Pat. No. 7,252,425 or U.S. Pat. No. 7,580,091 describes the edge-type backlight module. The light of light source emits a light guide from its one side. The light is then directed toward the LCD panel as mixed to a uniform light.

In addition to the way to dispose the backlight and the optical elements is different between the direct-type and the edge-type backlight module, the direct-type backlight module may require a larger space than the edge-type backlight module. However, the fabrication of direct-type backlight module is easier to conduct local dimming than the edge-type backlight module. U.S. Pat. No. 7,740,364 has disclosed an installation of direct-type backlight module uses the local dimming technology to enhance contrast ratio of the display. The thickness the display using the edge-type backlight module may be thinner since it uses a light guide. The local dimming technology may also be incorporated into the edge-type backlight, but it may meet interference among zones. On the contrary, the direct-type backlight module may perform shading and contrast adjustment by the local dimming.

In general, the LCD requires the light source with polarization to modulate the incident light. The light source for the backlight module is such as CCFL or LEDs that lacks of polarization property. Some other possible types of light sources such as HCFL, EFFL and OLED still lack of the property of polarization. Therefore, a polarizing plate is required for the LCD to polarize the incident light before entering the LCD. FIG. 1 schematically shows the fundamental structure of LCD. The structure includes several layers that form the pixel described as follows.

One of the layers of the main structure is a liquid-crystal layer 101. The liquid-crystal layer 101 includes liquid-crystal molecules. The top and bottom sides are the transparent electrodes, made of Indium Tin Oxide (ITO), that form the conductive glasses 104, 105 so as to generate electric field in the LC molecules. Further, two alignment films 102, 103 sandwiched respectively in between the liquid-crystal layer 101 and the two conductive glasses 104, 105. The grooves onto the alignment films 102, 103 force the LC molecules to be rotatably arranged in order. Types of liquid-crystal layer 101 are such as Twisted Nematic (TN), Vertical Alignment (VA), and In-Plane Switching (IPS), and the various types usually affect the contrast, angle of view, colors and brightness of the liquid-crystal layer 101.

The upper portion of the shown display structure includes a color filter 106. The color filter 106 is composed of a color photoresist and black matrix. The color photoresist is mainly made of red (R), green (G) and blue (B) that are able to filter the light to display the various colors. The black matrix allows the LCD to enhance contrast since the black matrix is able to prevent impure colors or declining the color gamut because of undue color blending resulting in light leakage. The mentioned electrodes are mainly made of ITO or ZNO (zinc oxide). Further, two polarizers 107, 108 having two perpendicular polarizing directions are disposed at up and bottom sides of the structure.

The backlight module 309 shown in FIG. 1 provides a uniform back light. The backlight module 309 is generally made of many optical elements, including a light source such as CCFL or LEDs, an optical substrate such as diffuser, a light guide, and any optical film such as brightness enhancement film and diffusion film.

As imaging, the light comes out from the backlight module 109, and passes through a bottom polarizer 108 so as to generate the light with polarized P or S light. The light further passes through the liquid-crystal layer 101, and is directed to the polarization direction by the LC molecules which are controlled by the inner electric field and the alignment films 102, 103. Then the top polarizer 107 defines the amount of light for controlling the lightness and brightness.

A general way to enhance the color gamut of the display is to modulate the spectrum of backlight. For example, if the backlight uses LEDs, the color gamut of display may be broader since the LEDs issue the narrower spectrum. On the contrary, if the backlight is CCFL, the color gamut may not be too broad since the CCFL covers broader spectrum. However, the color gamut may not be too broad in general after the light passes through the color filter. The color filter may therefore cause color distortion. Furthermore, the color filter may still cause crosstalk phenomenon between the transmittal spectrums of the colors. To sum up, in general the performance of color gamut of LCD may not be effectively enhanced since it is restricted by the color filter and the light source of backlight module 109.

In another example, the LEDs backlight may be applied to a direct type or edge type LCD. A white-light LED may be composed by the integration of red, green and blue LEDs. In particular, not only the backlight module adopting three independent red, green and blue LEDs renders broader spectrum than the one using CCFL, but also has broader color gamut.

However, some prior technologies use optimized methods for manufacturing color filters to improve the performance of color gamut of display. Such as the color filter shown in FIG. 1, the color filter may be added with pigments or dyes in the manufacturing process for enhancing the filtering property. The improvement of method may be applied to the legacy processes such as printing, etching, ink jet, or photo lithography. In the general technologies, light absorption is a way to implement the color filtering. However, almost two thirds of the amount of light will be consumed by absorption after the major portion of the light of the backlight module pass through the color filter. Further, the quality may be varying in color control and its range since it is difficult to completely control the pigments or dyes in the manufacturing method.

Also, the filter with various colors may result in crosstalk phenomenon. Reference is made to FIG. 2 showing a relationship of wavelength with unit of Nano and transmittance (%). The diagram shows the overlapped areas, the crosstalk, in between the red spectrum curve (2R), green spectrum curve (2G) and blue spectrum curve (2B) in the transmittal spectrum. The crosstalk phenomenon seriously affects the color base of the filter and that results in impure hue of each color. Thus the display may perform narrower color gamut.

### SUMMARY OF THE INVENTION

In addition to providing a backlight module with better color performance for enhancing the performance of color gamut of a display, disclosed in the present invention is related to a display panel mounted with a wide-color gamut film. The wide-color gamut film is particularly made of multiple layers. In accordance with the requirement of filtering out a certain waveband, the wide-color gamut film is configured to have a specific thickness and the refractive index for each layer. This claimed film is fabricated with a plurality of laminated filtering films with variant refractive indexes.

According to one of the embodiments of the present invention, disposal of the wide-color gamut film is sandwiched in between a panel module and a backlight module of the display apparatus. The wide-color gamut film having an overall thickness and an overall refractive index is preferably made of a plurality of layers of transparent thin films. One of the objectives of the wide-color gamut film in accordance with the present invention is to reduce or filter out the transmittance of light within one or more wavebands from the backlight module. The thin films composing the wide-color gamut film have different refractive indexes of the adjacent layers. The thin films are such as the layers made of the shown stacked first thin films and second thin films. The kinds of first and second thin films have different refractive indexes.

It is preferred that the wide-color gamut film includes a surface microstructure. The microstructure may be formed by a uniaxial stretching or biaxial stretching process which allows forming the polarized or non-polarized wide-color gamut film. In other words, the wide-color gamut film is formed as an absorption polarizing plate or a reflection polarizing plate. The design of transmittal spectrum for the wide-color gamut film renders a transmittance within at least one waveband smaller than 70%, 50% or 30%. Exemplarily, the mentioned waveband may be around the range of red light, green light or blue light.

According to one embodiment of the invention, the method for manufacturing the wide-color gamut film is firstly to assure the type of a backlight in the application. The method is then to decide one or more wavebands to be filtered, and thereby to define an overall thickness and an overall refractive index of the gamut film. Following design of the thickness and the overall refractivity, a plurality of high-polymeric thin films with various refractive indexes are prepared. The plural films having variant refractive indexes of the adjacent films are configured to be laminated according to the overall thickness. The wide-color gamut film is therefore formed based on the design specifying the overall thickness and overall refractive index.

In one further embodiment, the high-polymeric thin films at least include two different refractive indexes among the films. In the process of manufacture, the plurality of thin films having the different refractive indexes of the adjacent films may be made by a uniaxial or a biaxial stretching process. The uniaxial or biaxial stretching process allows the claimed wide-color gamut film to be with polarization or not. Further, the wide-color gamut film may be additionally adhered with an absorption polarizing plate or a reflection polarizing plate.

In accordance with the present invention, a display apparatus employed with the wide-color gamut film may essentially include a panel module of the display apparatus, a backlight module disposed aside to the panel module, and a wide-color gamut film sandwiched in between the panel module and the backlight module. The wide-color gamut film is made of a plurality of transparent thin films having different refractive indexes of the adjacent films. Thus the membrane of the wide-color gamut film has an overall thickness and overall refractive index due to the type of backlight module. One of the objectives of the claimed wide-color gamut film is to reduce or filter out the range over transmittance within one or more specified wavebands issued from the backlight module. Therefore the crosstalk phenomenon among the wavebands of the backlight spectrum may be improved for enhancing the purity of colors and the color gamut.

The mentioned panel module is applicable to a panel module of display apparatus. Main structure of the panel module includes a liquid-crystal layer, conductive glasses aside to the liquid-crystal layer, two alignment films disposed between the conductive glass and the liquid-crystal layer, and the polarizers. The mentioned polarizers are a first polarizer and a second polarizer whose polarization directions are perpendicular to each other. The polarizers are disposed outside the structure fabricated of the liquid-crystal layer, the conductive glasses and the two alignment films.

In particular, the wide-color gamut film is designed based on the type of backlight. The backlight of the backlight module may be CCFL, LEDs having three primary colors, LEDs with phosphor, light device mixed with LEDs, or the light device having OLEDs.

These and other various advantages and features of the instant disclosure will become apparent from the following description and claims, in conjunction with the appended drawings.

### BRIEF DESCRIPTION OF THE DRAWINGS

FIG. 1 schematically shows the structure of conventional LCD;

FIG. 2 shows relationship between the light wavelength and its transmittance;

FIG. 3 schematically shows one embodiment illustrating a display apparatus using the claimed wide-color gamut film;

FIG. 4 schematically shows one further embodiment illustrating a display apparatus using the claimed wide-color gamut film;

FIG. 5 is a schematic diagram describing structure of the wide-color gamut film in one embodiment of the present invention;

FIG. 6 illustrates the steps in the method for manufacturing the wide-color gamut film in accordance with the present invention;

FIG. 7A illustrates the spectrum of a CCFL;

FIG. 7B illustrates the spectrum of relative intensities among the colors of CCFL;

FIG. 7C shows a color space of the CCFL;

FIG. 8A illustrates the spectrum of a white-color LED;

FIG. 8B illustrates the spectrum of relative intensities among the colors of the LED;

FIG. 8C shows a color space of the white-color LED;

FIG. 9A illustrates the spectrum of the white-color LED mixed with three colors;

FIG. 9B illustrates the spectrum of relative intensities among the colors of the LED having the three colors;

FIG. 9C shows a color space of the white-color LED with three colors;

FIG. 10 describes one of the properties of the wide-color gamut film in one embodiment of the present invention;

FIG. 11 describes one further property of the wide-color gamut film in one embodiment of the present invention;

FIG. 12 describes another one property of the wide-color gamut film in one embodiment of the present invention;

FIG. 13A shows a diagram illustrating the intensity of the wide-color gamut film in accordance with the present invention;

FIG. 13B shows a characteristic diagram of a color space of the wide-color gamut film in accordance with the present invention;

FIG. 14A shows a second diagram illustrating the intensity of the wide-color gamut film in accordance with the present invention;

FIG. 14B shows a second characteristic diagram of a color space of the wide-color gamut film in accordance with the present invention;

FIG. 15A shows a third diagram illustrating the intensity of the wide-color gamut film in accordance with the present invention;

FIG. 15B shows a third characteristic diagram of a color space of the wide-color gamut film in accordance with the present invention.

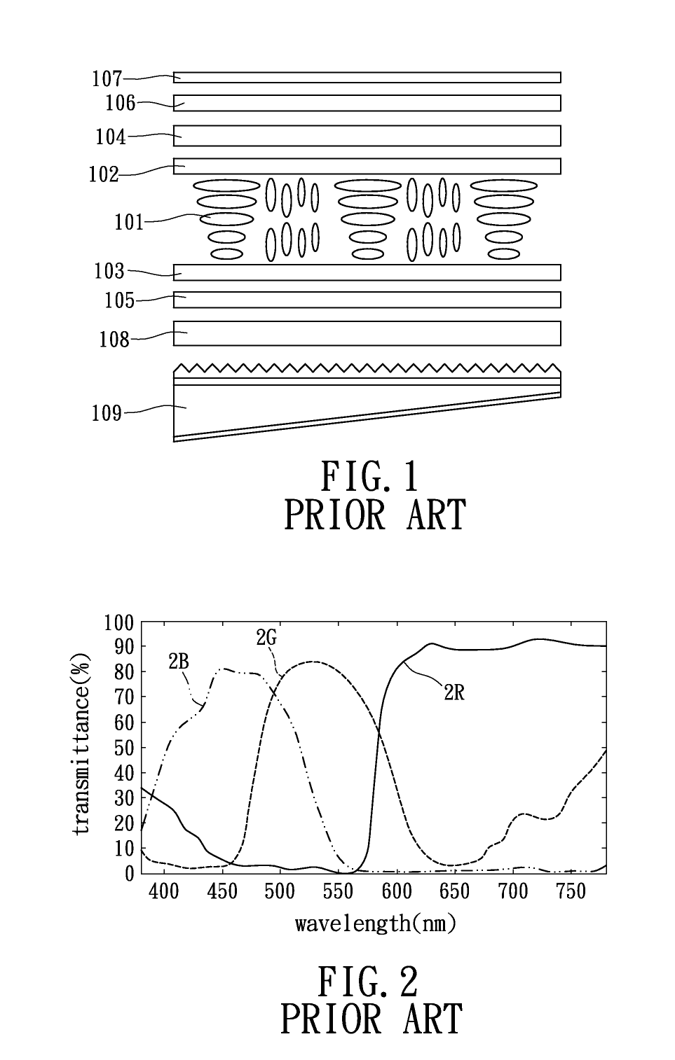

### DETAILED DESCRIPTION OF THE PREFERRED EMBODIMENTS

The types of a backlight module adapted to the LCD may be categorized into a direct type backlight and an edge type backlight. The backlight may adopt Cold Cathode Fluorescent Lamp (CCFL), LEDs or OLED. Further, the light source for the backlight module issues the light passing through several optical elements and being reflected, refracted, or/and optically interfered. However, the light may be greatly absorbed. The polarizer in the display panel may then polarize the light, but also greatly absorbs the light energy. After that, the other optical element such as a color filter may define the colors and depths of the polarized light.

The color gamut is a certain subsets of colors and is used to indicate the range of color space the each pixel is able to present. The size of area of the color gamut is exemplarily depending on the backlight source, filtering spectrum of color filter, and the type of liquid crystal that are the factors affecting the color gamut of display. The color gamut may be influenced if the backlight source is not suitable even though it uses an excellent display. The performance of the color gamut of the LC panel may be enhanced if the color gamut of the backlight module can be raised.

The performance of colors of the backlight source is desired to be broader when it uses much purer primary colors that results in better performance color gamut, or said color space. Thus the backlight source which is composed of three primary colors made by LEDs may have better performance. For example, the direct-type backlight generally provides better color gamut since it preferably adopts LEDs as the light source. If CCFLs or LEDs with phosphor are adopted to be the backlight source of display, a good color filter should be used in the display for filtering out the unnecessary light so as to generate better color gamut. Nevertheless, the general-purpose color filter is not able to provide the light with better color gamut since it is not designed to filter out any specific waveband of light. Based on the motivation of providing better performance light, provided in the disclosure of the invention is a method for manufacturing the wide-color gamut filter which is made of multiple layers. Therefore, the performance of color gamut of the display may be improved by filtering the unsuitable light.

The wide-color gamut film, a display apparatus disposed with the wide-color gamut film, and the method for manufacturing the wide-color gamut film in accordance with the present invention are provided. Rather than the conventional technology to improve the performance of color gamut of the display by improving the light property, the disclosure of the present invention is related to a wide-color gamut film disposed in the display apparatus for enhancing the range of color gamut. The claimed wide-color gamut film is particularly applicable to the backlight source using the conventional CCFL, LEDs, or OLEDs. In which, the claimed film also allows filtering out the specified waveband of light emitted from the conventional light sources. The backlight may therefore be much narrower and purer. The configuration of the invention is to filter out at least one range of waveband of the backlight.

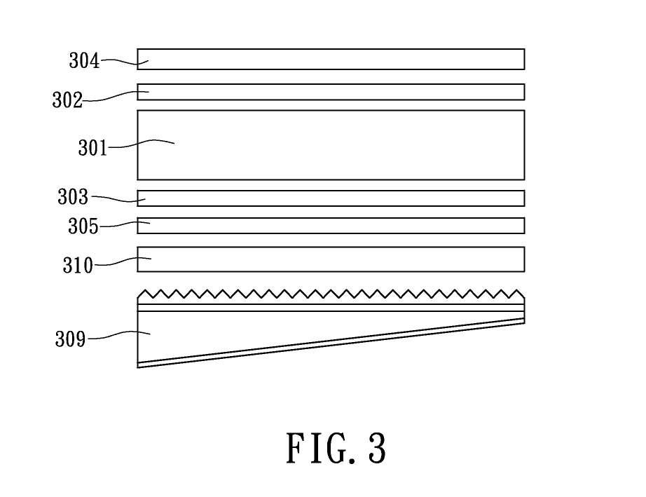

Reference is made to FIG. 3 schematically illustrating an embodiment of the display apparatus using the claimed wide-color gamut film.

According to the current embodiment, a wide-color gamut film 310 made of multiple thin films is disposed in the legacy LC display apparatus. In particular, the claimed film is applied to a display panel capable of displaying and modulating images. The display panel is exemplary in the midst of a liquid-crystal module 301, conductive glasses 302, 303, polarizers 304, 305, and a backlight module 309. The backlight module 309 may employ various light sources.

The display apparatus may provide space to contain various optical elements besides the mentioned display panel and backlight module 309. The one of optical elements is such as an optical film used to increase brightness or uniform light, and in particular as the wide-color gamut film 310 in accordance with the present invention. In one of the embodiments, the wide-color gamut film 310 is essentially composed of at least two kinds of inter-stacked optical films. One main function of the films is to reflect or filter a specified light waveband with respect to the lighting spectrum of the light source in the backlight module 309. One major purpose of the design is to increase the range of color gamut of the display. Because the general light source has very broad distribution of waveband, the membrane made of the claimed method using multiple films is configured to filter out one or more wavebands of the light. The claimed film is then combined with a panel module or a backlight module. The film allows the emitted light to have narrower or purer waveband of the light. Therefore, the performance of color gamut of the display apparatus can be enhanced.

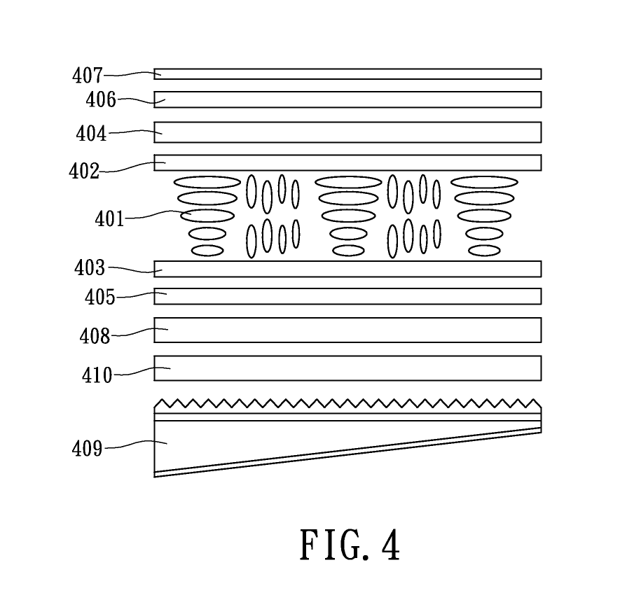

FIG. 4 shows one further schematic diagram of the display apparatus using the claimed wide-color gamut film in one embodiment of the present invention.

Major structure of the display apparatus is the panel module of the apparatus. In a liquid-crystal display, the panel module 40 includes a liquid-crystal layer 401, conductive glasses 404, 405 respectively disposed at top side and bottom side of the liquid-crystal layer 401, and two alignment films 402, 403 between the liquid-crystal layer 401 and conductive glasses 404, 405. In which, the conductive glasses 404, 405 are such as transparent electrodes used to generate a uniform electric field within the structure. The alignment films 402, 403 are responsible for aligning the LC molecules to be rotatably arranged. In a case of color LCD, a color filter 406 is incorporated. Two polarizers, which respectively include two perpendicular polarization directions, are disposed at the top and bottom sides of the whole panel module. In detail, the two polarizers are such as the shown first polarizer 407 and second polarizer 408 that are at outer sides of the structure including the liquid-crystal layer 401, two conductive glasses 404, 405 and two alignment films 402, 403.

According to the current embodiment, a backlight module 409 is disposed at one side of the panel module 40. Further, a wide-color gamut film 410 is in the midst of the panel module 40 and the backlight module 409. The position of the wide-color gamut film 410 may not be limited to lower position of the shown example but can be changed as required.

The wide-color gamut film 410 is constituted of a plurality of transparent thin films in which the films have different refractive indexes of the adjacent layers. The each layer's thickness (d) and the equivalent refractive index (n) are defined based on the type of light source of the backlight module 409. It is noted that the layer's refractive index may still be changed due to the light's polarization.

The wide-color gamut film 410 is fabricated by laminating a plurality of multilayer films. The transparent high-polymeric materials are the main component of the film 410. In an exemplary example, the number of optical membrane of the wide-color gamut film 410 may be dozens to hundreds of layers. This kind of multi-layer film is such as an optical interference thin film which is designed based on the principle of light interference. The general design of the optical interference thin film is composed of the films or membranes having various refractive indexes. The fabrication includes transparent dielectrics.

Inside the wide-color gamut film 410, the thickness of each membrane is around 50 through 1000 nanometers. One of the functions of the interference thin film is to allow passing through a specific waveband of light, or alternatively reflecting the light. Optical components are such as a filter able to band-pass, band-stop, long pass or short pass a certain spectrum, light-flux modulating device, optical switch, optical memory, and anti-fake tag. The wide-color gamut film 410 particularly incorporates the principle of optical interference. When two or more light waves are overlapped, it is called in-phase since the optical path difference there-between is integer times of the wavelength. Thus the “in-phase” phenomenon results in constructive interference between the light waves, and simultaneously raises the reflectivity. On the contrary, it is called out-of-phase when the optical path difference between two or more light waves is integer times of half wavelength. The “out-of-phase” waves result in destructive interference and reduce the reflectivity.

By inter-stacking the layers with difference materials and different thicknesses, the interference film is configured to reflect a specific wavelength of light, or allow passing the light. The design of whole film is based on the requirement of light waveband.

The disposal and fabrication of the wide-color gamut film 410 may be referred to the conventional technologies such as the U.S. Pat. No. 3,610,729, published on October 1971, U.S. Pat. No. 3,711,176, published on January 1973, or U.S. Pat. No. 5,976,424, published on Nov. 2, 1999. According to the conventional technologies, at least two high-polymeric materials with two different refractive indexes are used to form the properties of polarization and reflection to the wide-color gamut film. In particular, an extrusion process using a stretching machine is introduced to altering the molecule alignment and refractive index of the film. By means of the stretching process, the reflection of waveband, transmittance, polarization, and degree of polarization to the light entering the wide-color gamut film 410 is controllable. The detail description concerning the interference principle of multilayer film can be referred to the articles of H. A. Macleod's “Thin-film optical filters” and R. M. A. Azzam's “Ellipsometry and polarized light”.

The fabrication of wide-color gamut film employs the optical-stacked layer material such as PET (Poly(Ethylene Terephthalate)), PMMA (Poly(Methyl methacrylate)), or any other high-polymeric material such as PET, PEN (Poly(Ethylene Naphthalate)), PLA (Poly Lactic Acid), PMMA, PS (PolyStyrene), ETFE (Ethylene-Tetra-Fluoro-Ethylene), or the high-polymeric material blending the various polymers. The blending is such as the material blended with a certain percentage of PET and PEN.

While performing the extrusion over the wide-color gamut film to be made, a thicker skin layer (not shown) may be made to cover the skin of the membrane. This skin layer may be formed in the same extrusion process. The thicker structure of the skin layer stabilizes the multiple flow channels of the feedblock in the extrusion procedure. Further, the multilayer structure may be protected from the damage caused by the channels' shearing force while the materials flow over the channels. In one further embodiment, high-polymeric nano diffusion particles may be added inside the optical membrane and the skin layer. The additives may also be other kinds of functional particles that are made of nano metal, metal oxide particles, ceramic powders, dyes, or color powders. More, it is possible to dispose microstructure onto the surface of skin layer for facilitating capabilities of light diffusion and concentration. The capabilities of light diffusion and concentration enable the wide-color gamut film to mix the lights, especially for the backlight using point-light source such as LEDs. More, the colors issued from the LEDs can be effectively averaged.

It is worth noting that a stretching machine may be introduced to performing stretching process for aligning molecules and altering refractive indexes of the wide-color gamut film. By the stretching process, the reflectivity of specific waveband or mechanical characteristics of the claimed wide-color gamut film can be enhanced. Still further, a post-processing may be added for the process for manufacturing the wide-color gamut film for facilitating optical and mechanical characteristics. For example, a uniaxial stretching or biaxial stretching procedure may be performed as the post processing for increasing variations of refractive indexes. In which, the biaxial stretching method may be sequentially or simultaneously performed along the two axes. Differences existed in the refractive indexes of some specified materials along a specific direction may be increased by the stretching process. The effect of the differences of the refractive indexes may reduce the number of layers of the stacked high-polymeric materials, and an overall thickness. Reduction of total cost can therefore be accomplished.

If the uniaxial stretching process is performed to make the wide-color gamut film, the ratio to be stretched depends on the category of materials. This ratio under the uniaxial stretching method is around one to ten times when the materials of wide-color gamut film include a material with birefringence molecules. This birefringence material allows refracting the incident light to have a phase difference since the refractive indexes of the material along the directions x, y, z are not all identical, namely Nx≠Ny, Ny≠Nz, or Nx≠Nz. Where the Nx, Ny and Nz are indicative of the refractive indexes along the x, y, and z directions respectively. The birefringence material renders the incident light to have retardation. The polarization of the light can be modified since the birefringence material changes the phase difference of the light. Therefore the wide-color gamut film may render both the functions of filtering and reflective polarization.

The wide-color gamut film is configured to allow passing through the polarized light specified to have a narrow waveband due to its design of inter-stacked multiple films. The wide-color gamut film is exemplarily disposed in a backlight module. A relative angle between the wide-color gamut film and a LC panel is adjustable. In one exemplary example, a reflection axis of the wide-color gamut film and the LC panel maintains an included angle. The included angle is modified depending on disposal of a polarizing plate adhered to the LC panel. The wide-color gamut film is preferably disposed underneath the display panel.

Inside the backlight module, according to one of the embodiments, it is possible to obtain high luminance if the wide-color gamut film is disposed above the light guide plate or diffusion plate. On the contrary, high uniformity may be obtained if the wide-color gamut film is disposed underneath the diffusion plate or light guide plate.

One of the functions rendered by the wide-color gamut film 410 is to tune transmittance of one or more wavebands of the spectrum issued by the backlight module 409. The wide-color gamut film 410 may reduce or filter out the energy of light within one or more wavebands when the light from the backlight module 409 passes through the wide-color gamut film 410. In accordance with the present invention, the wide-color gamut film 410 is incorporated to filtering out certain waveband so as to solve the crosstalk phenomenon between colors shown in FIG. 2. Thus the performance of color gamut of the display apparatus may be improved.

In an example of the backlight module 409 with LEDs including red, green and blue lights, one major subjective of the claimed wide-color gamut film 410 is to reduce the crosstalk phenomenon between the wavebands of the red, green and blue lights.

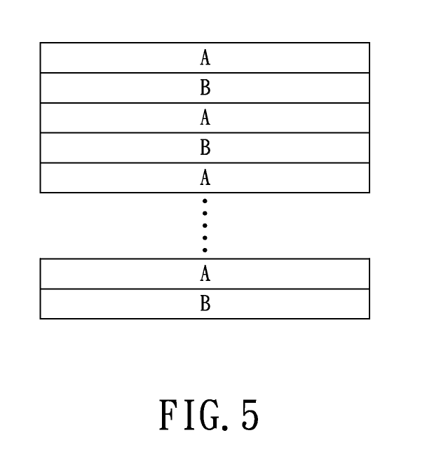

Reference is made to FIG. 5 describing the structure of wide-color gamut film. The structural features of the wide-color gamut film are made based on the wavebands desired to be reflected. The wide-color gamut film is made of multiple films. The included optical membranes are around dozens to hundreds of layers. The membranes are functioned to allow passing the light with a certain waveband, or simultaneously reflecting the light with other wavebands. In the current example, the dozens to hundreds of layers categorized as a first thin film A and a second thin film B are inter-stacked, and in particular the adjacent thin films therein have different refractive indexes.

Further, the thickness (d) of the each film A or B and its refractive index (n) are designed based on the object the claimed wide-color gamut film is adhered to. By inter-stacking the two kinds of the thin films, the fabricated structure may be achieved to have an overall refractive index, and simultaneously have an overall thickness. To reach a specific requirement, the wide-color gamut film is configured to have the characteristics of birefringence by incorporating the required materials and the process to make the film. The transmittal spectrum curve required to conform the need of the wide-color gamut film is measured by a spectrum meter.

In one embodiment, the physical characteristics of the wide-color gamut film can be measured by the wavelength with four-times refractive index (n) multiplied by the thickness. Therefore, the requirement of the waveband to be reflected can be reached by configuring the films to be stacked. The inter-stacked thin films meet the requirement of an overall refractive index. Thus the reflection spectrum of the wide-color gamut film can be precisely measured by calculating a reflection matrix of the membrane based on an interference principle.

In addition to the main membrane of the wide-color gamut film, surface structure or any added functional film may be accompanied with the wide-color gamut film for producing any other optical properties. In an exemplary example, the surface microstructure is functioned to concentrate, refract, or/and uniform the light. One of the other functional films is such as the film having protective multilayer. The mentioned microstructure is such as prism, pyramid or cylindrical structure formed on the surface of the film. The surface structure onto the wide-color gamut film may be formed as one or in combination of the types of structure. The surface structure is not only to uniform the light, but also protect the inside matter.

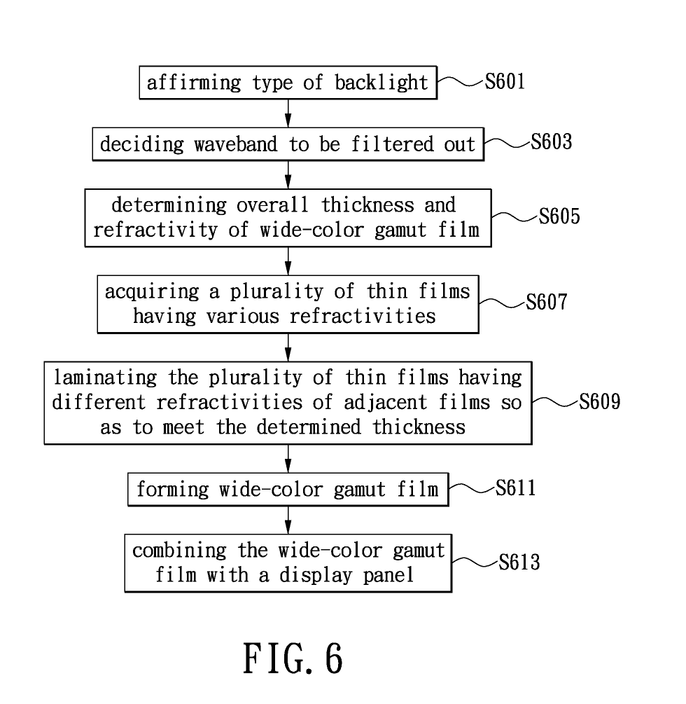

Reference is made to FIG. 6 illustrating the steps for manufacturing the membrane including multiple layers with different adjacent refractive indexes, such as the embodiment shown in FIG. 5.

Following steps illustrate the embodiment of the method for manufacturing the claimed wide-color gamut film. In the beginning step such as S601, the type of the backlight is firstly ascertained. The backlight type is such as CCFL, LEDs having three primary colors, the white-light LEDs with blended colors, or OLED. The various types of the backlight require filtering the light with different wavebands. The disclosure related to the present invention describes the various embodiments.

After verifying the type of backlight, such as step S603, it determines the wavebands ready to be filtered. For example, the wavebands around the red light, green light, and blue light would be filtered. The configuration is adapted to design the structure of wide-color gamut film, exemplarily including thickness or refractive index of the whole wide-color gamut film (step S605). In step S607, the thin films with various refractive indexes are acquired, including at least two different refractive indexes. The thin film is preferably made of high-polymeric substance. According to the determined thickness of the film, such as step S609, the thin films with different refractive indexes between the adjacent films. After combining the thin films, in which the adjacent films have different refractive indexes, the membrane is formed to have the overall thickness and the refractive index. The combination may be implemented by adhesion or lamination. The membrane with the overall thickness or refractive index forms the wide-color gamut film associated with a specific backlight (step S611).

The wide-color gamut film is thus combined with a display panel (step S613). The embodiments are such as shown in FIG. 3 or FIG. 4. The wide-color gamut film is disposed underneath the panel. The film and the panel may be engaged immovably with each other, or fixed separately. A pressure sensitive adhesive (PSA) may be adopted to laminate the film and the panel. A method of UV curing may also be used to do the combination. PSA or any curing glue may use the material with low refractive index around 1.1 to 1.4, and enhance the luminance and uniformity of the display panel. The microstructure of the wide-color gamut film is such as the structure of prism, micro-lens, or pyramid that is served to concentrate the light, and may also improve the luminance and uniformity. The backlight module is mechanically combined with the wide-color gamut film. The mentioned pressure sensitive adhesives may be used to laminate the articles. Thermal curing, UV curing, or any other chemical way may also be the solution to conduct the lamination. In one further embodiment, the wide-color gamut film may be disposed above the conventional brightness enhancement film, diffusion film, diffusion plate, or light guide plate.

The above-mentioned display panel may include the polarization plate or non-polarization plate. The polarization plate may be absorptive or reflective type. The feature of polarization allows the wide-color gamut film to provide more functions to assist the display panel.

For example, the process to make the multilayer may be in combination of the step for adhering or laminating thin films, and also accompanied with uniaxial stretching or biaxial stretching. The stretching process renders the wide-color gamut film to have polarization or not. The polarization feature facilitates the manufacturing method to conduct polarization conversion. The birefringence of the film made by the stretching process renders part of the polarization conversion.

In consideration of color performance, the film may provide weaker polarizing reflection. Therefore, an absorption polarizing plate or a reflection polarizing plate may be adhered to one side of the wide-color gamut film for effectively facilitating the polarization conversion, by which the wide-color gamut film is featured by both the color performance and polarization conversion. In an exemplary example, the absorption polarizing plate may be incorporated to manufacturing an absorption-type wide-color gamut film. Alternatively, the reflection polarizing plate makes the wide-color gamut film to be a reflection-type film. The reflection-type or absorption-type film is then combined with the display panel or the backlight module.

Further, if the claimed film is applied to the display panel without polarizer, this wide-color gamut film may also take place of some functions therefor such as brightness enhancement or polarization. The reflection-type wide-color gamut film can increase the contrast of panel and enhance its brightness. The absorption-type wide-color gamut film can also increase the contrast and part of brightness of the display panel.

In accordance with the embodiment of the present invention, the wide-color gamut film may be adhered to the bottom side of the display panel. If the film is disposed on the top side of the backlight module, the color gamut of the display can be enhanced. The other types of functional thin films such as reflection polarizing plate or absorption polarizing plate may be incorporated to increasing the contrast and polarization of the panel. In order to facilitate light concentration and mixture, the wide-color gamut film may be formed with surface microstructure, or equipped with low-refractivity pressure-sensitive adhesive or curing glue sandwiched in between the display panel and the backlight module.

When the claimed wide-color gamut film with narrow frequency spectrum in accordance with the requirement of waveband is applied, the display may still render a qualified color gamut for the legacy color filter in the display is removed. If the display using the claimed wide-color gamut film is accompanied with the LED or OLED high-speed switching backlight, the color filter may not be requisite for the backlight module or display. That means the wide-color gamut film substitutes for the color filter. In the meantime, the brightness of the panel may be enhanced if the wide-color gamut film is disposed with the absorption polarizing plate or reflection polarizing plate.

The wide-color gamut film is configured to allow its transmittal spectrum to have a non-continuous distribution within in a specific waveband. The transmittance within this non-continuous waveband has an obvious wave valley relative to the adjacent wavebands. It is featured that the wave valley of the transmittance is particularly close to the zone of crosstalk made by the color filter. The transmittance of wide-color gamut film reaches a relatively low point of the spectrum, and results in the non-continuous waveband of transmittance around the zone of crosstalk phenomenon. It is noted that the non-continuous waveband is required as low as possible.

The wavelength of human eye-visible electromagnetic waveband is around 400 nm to 780 nm. The wavelengths of three primary colors are around 620 to 750 nm of red color, 495 to 570 nm of green color, and 450 to 475 nm of blue color. The three colors (red, green and blue) are referred to divide the transmittal spectrum into several zones. The type of backlight of the display may be referred to the exemplary examples illustrated in the disclosure.

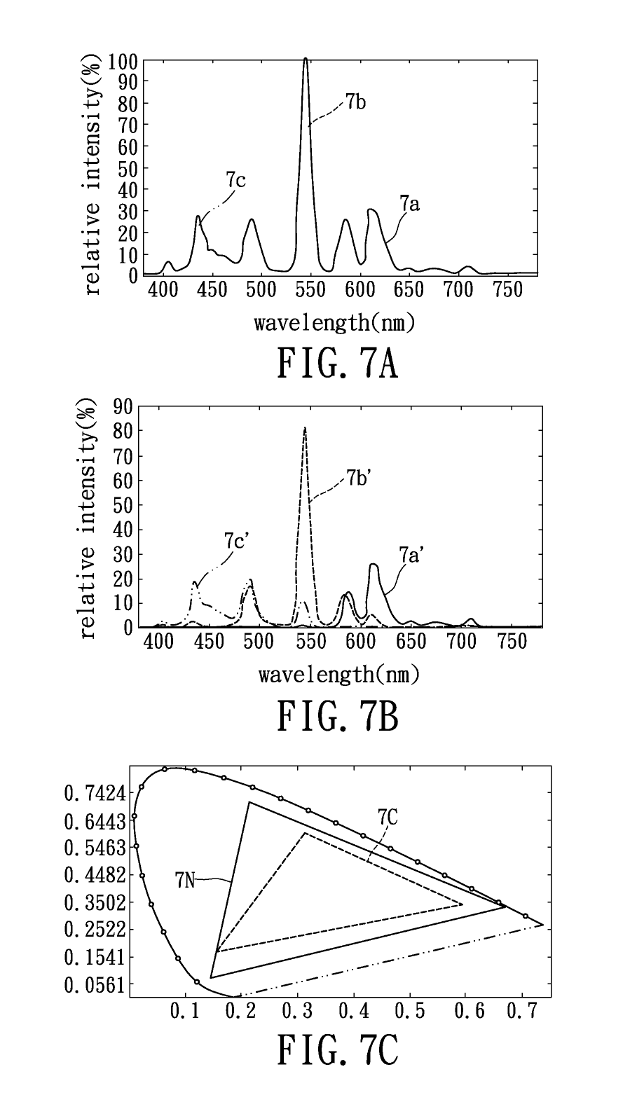

Reference is made to FIG. 7A illustrating the transmittal spectrum of CCFL. The vertical axis indicates a relative intensity (%) of a light source. The horizontal axis indicates wavelength (nm) of light. The diagram shows several relatively high peaks such as the shown red-light waveband 7a, green-light waveband 7b and blue-light waveband 7c. However, the colors appear uneven performances, for example the zones 7a, 7b and 7c are about indicatively the red, green and blue wavebands for CCFL. Compared to Laser, CCFL has broader distribution of the three primary colors.

FIG. 7B shows the transmittal spectrum of the relative intensity for the colors of CCFL. The color, green and blue color filters are employed to acquire the each color's intensity. As shown in the diagram, a blue color filter is used to draw the curve 7c′ indicative of intensity distribution of blue color. The curve 7b′ indicates the intensity distribution of green color through a green color filter. Still, curve 7a′ indicates the intensity distribution of red color when the light of CCFL passes through the red color filter.

From the intensity distributions of the colors of CCFL, the every color's distribution may overlap other wavebands. The distributions appear the colors of CCFL are impure.

FIG. 7C next describes a color space related to CCFL. A shown zone 7C denotes the performance the color gamut in color space of CCFL. In which, the zone 7N denotes the performance of an NTSC (National Television System Committee) standard color space. The zone 7C is not yet employing the wide-color gamut film in accordance with the present invention, and able to be a control group compared to the effect of the invention.

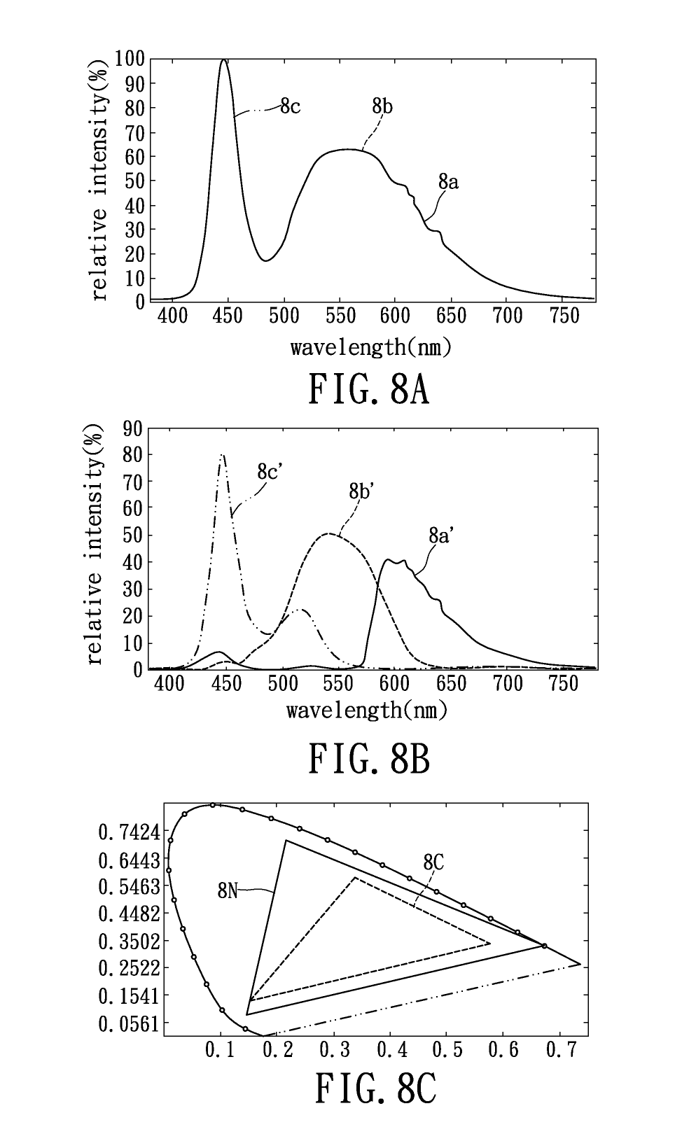

FIG. 8A describes a transmittal spectrum of a white-light LED. One of the types of the white-light LED is embodied by using a blue LED to stimulate yellow phosphor (phosphor-based LED). The spectrum appears a blue-light waveband 8c distributed over a left zone of the diagram. This zone 8c shows no obvious distinction with the red-light zone (8a) and green zone (8b). The claimed wide-color gamut film is therefore to improve the color gamut of the light source.

FIG. 8B illustrates a transmittal spectrum of the colors resolved by a white-light LED, such as using the red, green and blue filters to acquire the separate colors. The curve 8c′ indicates the intensity distribution of blue light as the light passing through blue filter. The curve 8b′ shows the intensity distribution of filtered green light. The curve 8a′ shows the intensity distribution of red light. The performance of each color's intensity described by the curve is incorporated to be the control group for testing the wide-color gamut film.

The distributions of the colors appear the every color's intensity of the white-light LED over the wavebands. The intensity distributions show the overlapped areas that are known by the skilled person as the crosstalk phenomenon.

FIG. 8C illustrates color space of white-light LED. The zone 8N denotes an NTSC-standard color gamut. The zone 8C is the color gamut of white-light LED. It is noted that the performance of color gamut can be evaluated by its surrounded area.

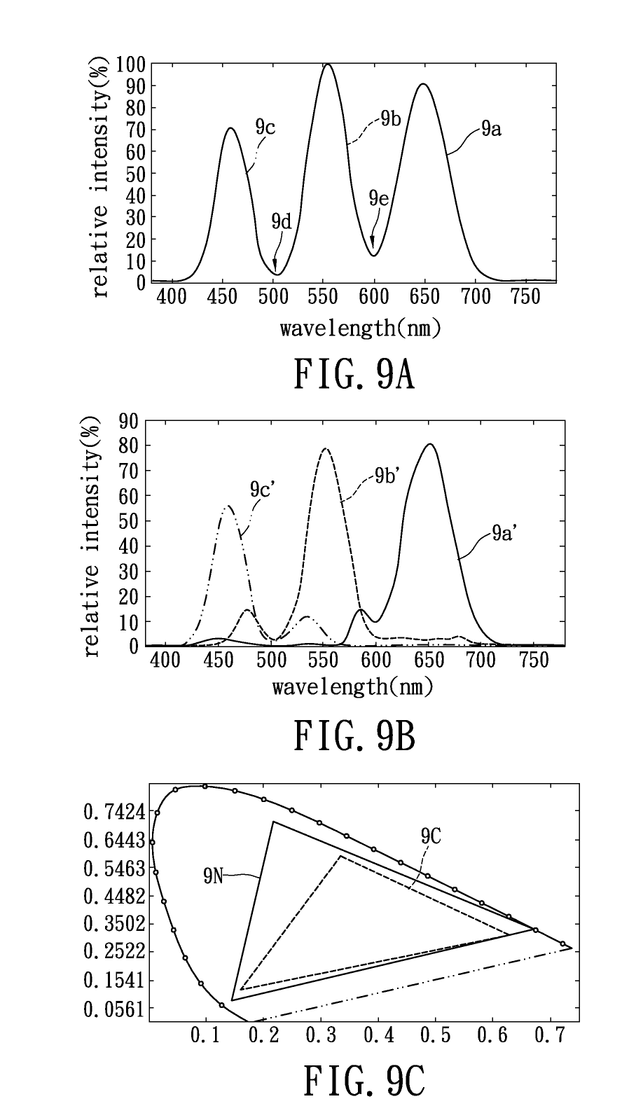

Further, reference made in FIG. 9A illustrates the transmittal spectrum of the white-light LED produced by mixing three colors such as three primary-color LEDs. The diagram shows the spectrum of individual red, green and blue lights mixed to produce this white-light LED.

The light source using three primary-color LEDs may usually to be a preferred way to implement the backlight. In the diagram, a blue-light waveband 9c is appeared around the visible blue-light wavelength. Also, the green-light waveband 9b is around the wavelength of green light, and the red-light waveband 9a is around the wavelength of red light. The spectrum shows several zones with non-continuous and lower transmittance, for example the range of 500 nm (9d) to 600 nm (9e). In which the waveband with lower transmittance is around tens of nanometers.

Still further, FIG. 9B shows the transmittal spectrum with relative intensities of the three colors mixed to form the white light. Through the red, green and blue filters, it appears all the colors mixed to be the white-light LED perform good relative intensities. The curve 9a′ indicates the red light distribution. The curve 9a′ shows a great performance of the light source even though it still shows some noises around the wavebands other than the main waveband (around 650 nm) of red light. The curve 9b′ indicates the green light distribution. The curve 9b′ shows there is no conspicuous intensity other than the waveband around 550 nm. Further, the curve 9c′ indicates the blue light distribution where there is no conspicuous intensity other than waveband around 460 nm.

FIG. 9C illustrates the color spaces of both NTSC-standard color gamut 9N and the color gamut 9C of the white-light LED mixed with three colors.

Based on the above description related to the applications of the present invention, one of the objectives of the claimed wide-color gamut film is to reduce the overlapped areas between the wavebands of colors. The major function of the wide-color gamut film is to reduce the crosstalk especially the most serious ranges since the overlapped areas usually cause the crosstalk phenomenon. However, if the overlapped areas with the crosstalk are effectively reduced, the most of light may be blocked by the film since the broader range of lower transmittance is simultaneously filtered out. The reduction of transmittance may also reduce the luminance of a liquid-crystal panel. In accordance with the present invention, the design of wide-color gamut film will also consider the drawbacks of reducing the luminance when solving the problem of crosstalk. It is noted that the lower value of the transmittance, the more it is able to reduce the crosstalk phenomenon.

It is worth noting that the luminance may be reduced when the performance of color gamut of the color filter is improved by filtering out the necessary lights. Further, the polarization function of filter in the panel may also loss almost half of the luminance. The claimed wide-color gamut film may be designed in consideration of both color gamut improvement and loss of luminance. In an exemplary example of the present invention, the spectrum of the wide-color gamut film featured with the transmittance selected by its lowest transmittance within at least one waveband lower than 70%, preferably lower than 50%, or moreover lower than 30%. In general, the transmittance of the wide-color gamut film of the present invention is measured and defined by averaging the natural non-polarization p light and s light. If it is required to measure the transmittal spectrum of a specific polarizing light, a polarizer such as a polarizing plate is used to generate a light with a polarization direction.

Accordingly, the following diagrams illustrate the experimental data associated with the properties of wide-color gamut film in accordance with the present invention.

### First Embodiment of Wide-Color Gamut Film

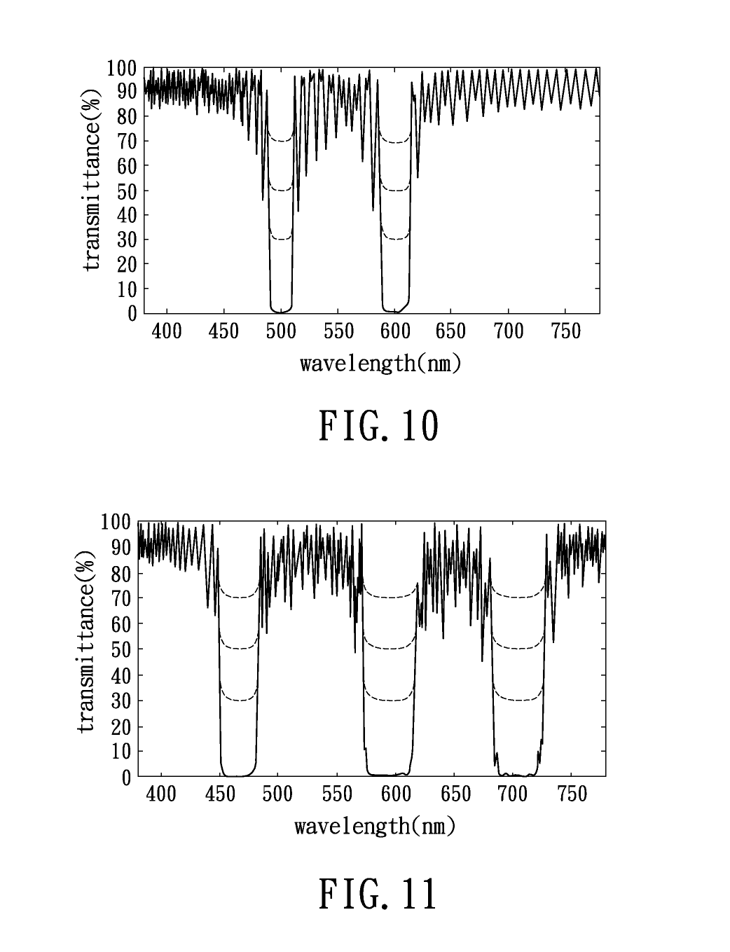

Reference is made to FIG. 10 describing the property of the wide-color gamut film made by multiple films.

The wide-color gamut film shown in FIG. 10 is formed by inter-stacking the multiple layers of transparent thin films, in which the adjacent films have different refractive indexes. The wide-color gamut film therefore renders an overall thickness and refractive index in accordance with a specific requirement. For example, the current film is featured to provide lower transmittances around 500 nm and 600 nm. The transmittances are preferably lower than 70%, 50% or even 30%. The curves depicted with dotted lines are referred to the 70%, 50% and 30% transmittances. The portions of wavebands other than the ranges around 500 nm and 600 nm may maintain high transmittances especially the wavebands of red, green and blue lights. It is evidenced that the wide-color gamut film effectively blocks some specified lights, such as the ranges around the 500 nm and 600 nm according to the present example. Therefore, the crosstalk phenomenon can be effectively improved.

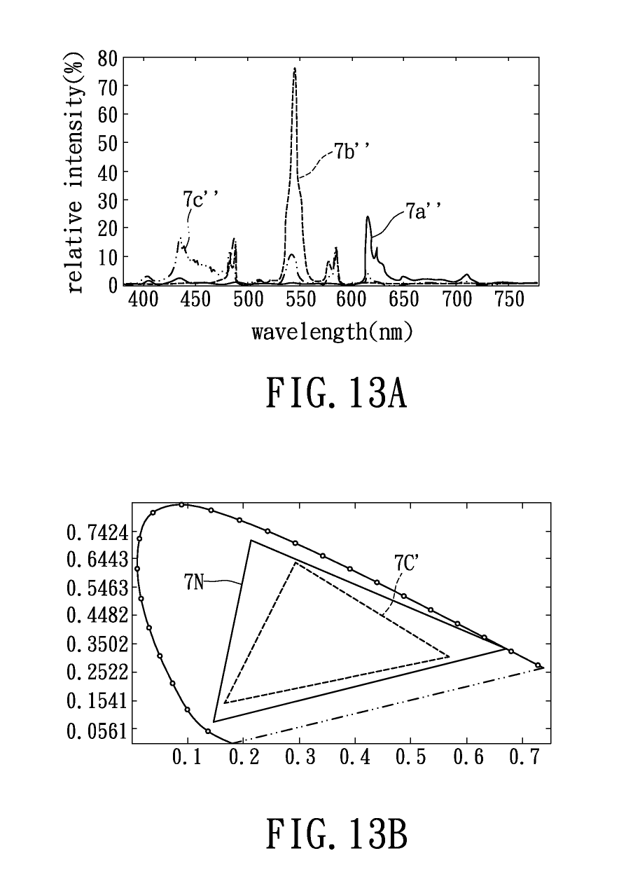

FIG. 13A shows a spectrum of CCFL with the relationship of the relative intensity (%) and wavelength (nm) when the wide-color gamut film described in FIG. 10 is applied to CCFL referring to the property described in FIG. 7A,

Compared to the property of CCFL shown in FIG. 7B, FIG. 13A appears an obvious improvement of the distribution of the colors resolved from CCFL when it uses the wide-color gamut film characterized in FIG. 10. Three curves are shown in FIG. 13A, and individually indicate the lights passing through the wide-color gamut film. When a color filter is applied, the spectrum shows the relative intensities including the curve 7a″indicative of a red light distribution, the curve 7b″ indicative of a green light distribution, the curve 7c″ indicative of a blue light distribution, and the rest wavebands.

According to the result of the experiment, the spectrum appears there are several relative high intensities around the wavelengths around the red, green and blue colors. That means the wide-color gamut film characterized in FIG. 10 effectively filters out the lights around 500 nm and 600 nm in this example, and allows the relative high performances of the three colors.

Next, FIG. 13B shows the color space of CCFL when it is applied with the wide-color gamut film characterized in FIG. 10. It appears that the area of color gamut 7C′ is larger than the color gamut 7C shown in FIG. 7C when the CCFL is not yet applied with the wide-color gamut film.

After calculating the area, the color gamut 7C in FIG. 7C occupies 50.6% of the area of NTSC-standard color gamut, and the color gamut 7C′ described in the current diagram is 55.8% of the area of NTSC color gamut. The wide-color gamut film allows the improvement of performance of color gamut of CCFL.

### Second Embodiment of Wide-Color Gamut Film

The wide-color gamut film characterized in FIG. 11 allows the transmittances around 470 nm, 590 nm and 700 nm to approach zero. These ranges are corresponding to the wavelengths of the primary colors, for example the waveband of red light is ranged over 620 to 750 nm, the green light is over 495 to 570 nm, and the blue light is over 450 to 475 nm. Therefore, the claimed wide-color gamut film effectively enhances the performance of the transmittances of the three primary colors. In addition to the transmittance approaching zero made by the claimed wide-color gamut film, it also allows the transmittances within wavebands around the red, green and blue lights to be lower than 70%, 50% or 30%.

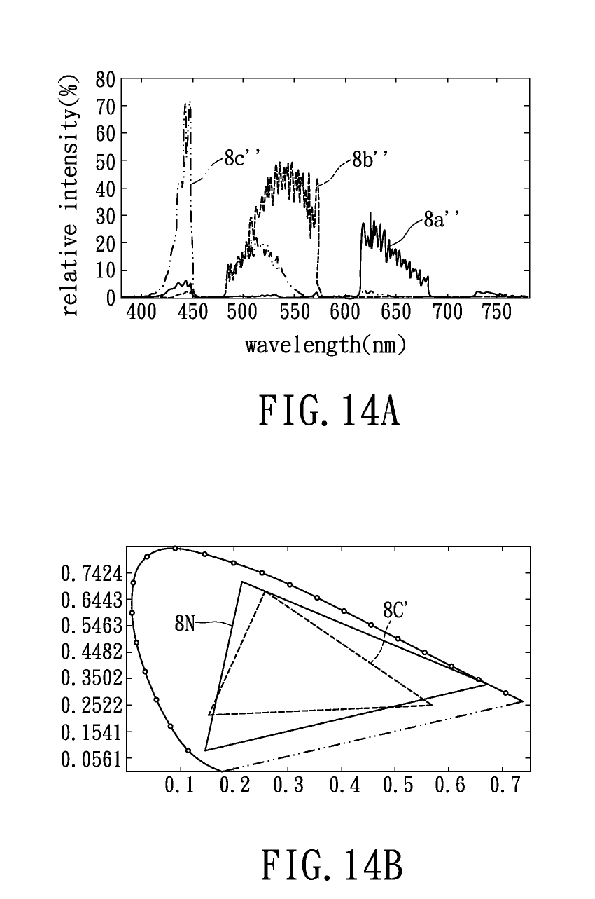

When the wide-color gamut film is applied to the white-light LED described in FIG. 8A, the corresponding wavebands shown in FIG. 11 may be filtered out. According to an exemplary example, such as the spectrum shown in FIG. 14A, it appears the lights around 450 nm to 470 nm, and 570 nm to 620 nm are filtered out. After that, the red light distribution (8a″), the green light distribution (8b″), and the blue light distribution (8c″) are improved. The performance of color gamut is then referred in FIG. 14B.

The color gamut shown as zone 8C′ is compared to the color gamut 8C in FIG. 8C. After calculating the area of color gamut in the color space, the color gamut 8C occupies 48.4% of NTSC-standard color gamut. When the white-light LED is applied with the claimed wide-color gamut film, the color gamut 8C′ is 58.7% of the NTSC-standard color gamut. It appears that the claimed wide-color gamut film effectively improves the color gamut of the white-light LED.

### Third Embodiment of Wide-Color Gamut Film

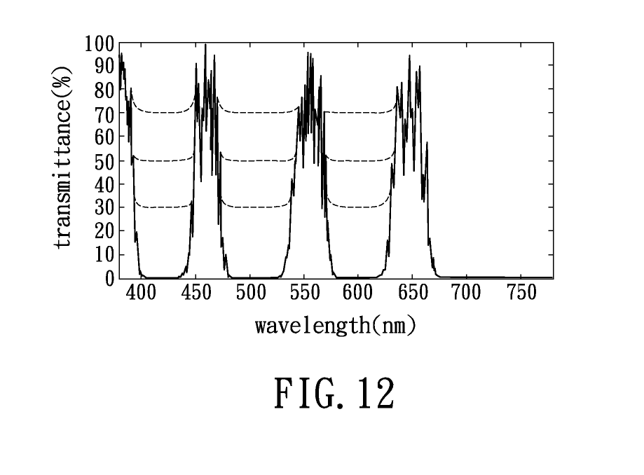

Reference is made to FIG. 12. The spectrum shows the transmittances around the wavelengths 400 nm to 440 nm, 480 nm to 530 nm, and 580 nm to 620 nm are obviously reduced to approach zero. This wide-color gamut film effectively blocks the light having the wavebands within these three zones. In particular, the transmittances within the wavebands rather than the ranges of red, green and blue lights are reduced to zero, or exemplarily lower than 70%, 50%, or 30%. The reduction of specified range of light allows enhancing the performance of the primary colors of the backlight.

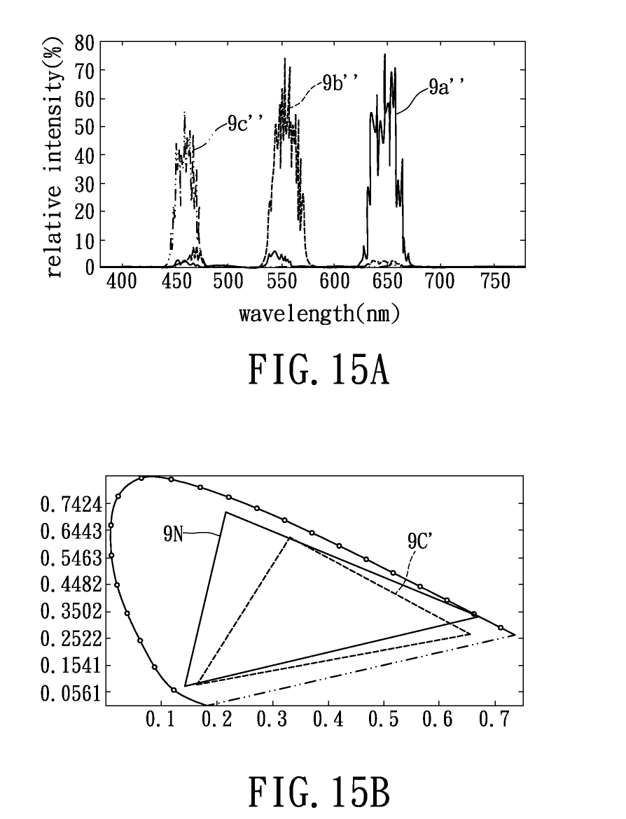

The spectrum shown in FIG. 15A evidences the great performance of the white-light LED made by mixing three colors. It appears that the red light distribution 9a″ has outstanding performance around the range of 440 nm to 480 nm since the two adjacent zones of the red light range are filtered out by the wide-color gamut film. Also, both the green light distribution 9b″ around 530 nm to 580 nm and the blue light distribution 9c″ around 620 nm [symbol] 670 nm have the great performances.

After applied with the claimed wide-color gamut film, the performance of color gamut of the white-light LED is greatly enhanced. For this example, compared to the color gamut 9C shown in FIG. 9C, the color gamut 9C′ of wide-color gamut film is much improved. In FIG. 9C, the area color gamut 9C occupies 59.6% of NTSC-standard color gamut. After the application of wide-color gamut film as shown in FIG. 15B, the color gamut 9C′ occupies about 73.6% of NTSC area.

The above-referenced embodiments of the present invention are specified to a specific wide-color gamut film and light source. One major objective of the embodiment is to administrate the effect of the wide-color gamut film by comparing the experiment with the control group. The result shows the claimed wide-color gamut film effectively improve the performance of the several types of the conventional light sources.

The wide-color gamut film may be applied to various types of backlight modules made by, but not limited to, CCFL, LEDs, and OLEDs. According to the experiments, the backlight with CCFL is greatly improved when it is applied with the claimed wide-color gamut film.

To sum up the above description, the present invention is related to a wide-color gamut film and a method to manufacture the film. The design of wide-color gamut film is employed to some specific light sources. With the specified thickness and refractive index using the multiple layers, the wide-color gamut film is able to filter out some specific wavebands of light. Further, the provided wide-color gamut film is rather than the conventional color filter which easily produces crosstalk. This wide-color gamut film is an optical element capable of suppressing the transmittances within some wavelength ranges. The wide-color gamut film effectively improves the crosstalk phenomenon without too much modification of the conventional method for manufacturing the panel.

While the above description constitutes the preferred embodiment of the instant disclosure, it should be appreciated that the invention may be modified without departing from the proper scope or fair meaning of the accompanying claims. Various other advantages of the instant disclosure will become apparent to those skilled in the art after having the benefit of studying the foregoing text and drawings taken in conjunction with the following claims.

What is claimed is:

1. A display apparatus having a wide-color gamut film, comprising:
a panel module of a display apparatus;
a backlight module, disposed at one side of the panel module; and
a wide-color gamut film, disposed between the panel module and the backlight module, wherein the wide-color gamut film is composed of a plurality of transparent thin films and the adjacent films have different refractive indexes, and an overall thickness and an overall refractive index of membrane of the wide-color gamut film is configured by referring to a light-source type of the backlight module, whereby the wide-color gamut film is used to reduce transmittance or filter out one or more wavebands of the backlight from the backlight module;
wherein, the membrane with the overall thickness and the overall refractive index provides a solution to the crosstalk phenomenon among multiple wavebands of backlight.

2. The display apparatus according to claim 1, wherein the panel module is applied to a display apparatus, and the comprises:
a liquid-crystal layer;
two conductive glasses disposed at two sides of the liquid-crystal layer;
two alignment films respectively disposed between the two conductive glasses and the liquid-crystal layer; and
a first polarizer and a second polarizer, and two polarization directions of the two polarizers are perpendicular, wherein the first polarizer and the second polarizer are respectively disposed on the two conductive glasses at two sides of the liquid-crystal layer, and with the two alignment films forming the outer structure of the display apparatus.

3. The display apparatus according to the claim 2, wherein the wide-color gamut film is sandwiched in between the second polarizer and the backlight module.

4. The display apparatus according to the claim 3, wherein the wide-color gamut film and the backlight module are mechanically combined.

5. The display apparatus according to the claim 3, wherein the wide-color gamut film and the backlight module are laminated with pressure-sensitive glue.

6. The display apparatus according to the claim 3, wherein the wide-color gamut film and the backlight module are laminated with a thermal curing or ultraviolet curing glue.

7. The display apparatus according to the claim 1, wherein the lights with multiple wavebands is a red light, green light, and a blue light.

8. The display apparatus according to the claim 1, wherein a light source of the backlight module is made of cold cathode ray tube, LEDs with three primary colors, white color lights defined by mixing LEDs, or organic LEDs.

9. The display apparatus according to the claim 1, wherein surface of the wide-color gamut film has microstructure.

10. A wide-color gamut film, sandwiched in between the panel module and the backlight module, characterized in that the wide-color gamut film are composed of a plurality of transparent thin films in which the adjacent films have different refractive indexes, and has an overall thickness and an overall refractive index; the wide-color gamut is used to reduce or filter out the light transmittance in one or more wavebands of the backlight module.

11. The wide-color gamut film according to the claim 10, wherein the adjacent thin films are with refractive indexes, and are inter-stacked films including a first thin film with a refractive index and a second thin film with another refractive index.

12. The wide-color gamut film according to the claim 10, wherein surface of the wide-color gamut film has at least one kind of microstructure.

13. The wide-color gamut film according to the claim 10, wherein the wide-color gamut film includes uniaxial stretching or biaxial stretching thin films.

14. The wide-color gamut film according to the claim 13, wherein polarization of the wide-color gamut film allows the wide-color gamut film to be an absorption polarizing plate or a reflection polarizing plate.

15. The wide-color gamut film according to the claim 10, wherein the wide-color gamut film has the transmittance with at least one waveband smaller than 70%, 50% or 30%.

16. The wide-color gamut film according to the claim 15, wherein the transmittance of the wide-color gamut film with spectrum approaching a red light, a green light and blue light is smaller than 70%, 50% or 30%.

17. A method for manufacturing a wide-color gamut film, comprising
in response to multiple wavebands to be filtered as specifying a type of backlight, the wide-color gamut film configured to have an overall thickness and an overall refractive index, and composed of a plurality of transparent thin films in which the adjacent films have different refractive indexes;
according to the required overall thickness, combining the plurality of thin films and the adjacent films have different refractive indexes; and
forming the wide-color gamut film with the required overall thickness and the overall refractive index.

18. The method of claim 17, wherein the thin films composing the wide-color gamut film include at least two refractive indexes.

19. The method of claim 17, wherein the thin films with different refractive indexes of the adjacent films are produced by a uniaxial stretching or biaxial stretching process that defines the wide-color gamut film to have or not to have polarization.

20. The method of claim 17, wherein a reflection polarizing plate is adhered to one side of the wide-color gamut film after laminating the plurality of thin films.
